(19) United States
(12) Patent Application Publication
(10) Pub. No.: US 2007/0294662 A1
(43) Pub. Date: Dec. 20, 2007

(54) Integrated Service Method of Distribution Software for Robot Development Based on Open Internet Network

(75) Inventors: Hong-Ryeol Kim, Seoul (KR); Dae-Won Kim, Gyeonggi-do (KR); Hong-Seong Park, Seoul (KR); Hong-Seok Kim, Seoul (KR); Ho-Gil Lee, Gyeonggi-do (KR)

Correspondence Address: NEEDLE & ROSENBERG, P.C., SUITE 1000, 999 PEACHTREE STREET, ATLANTA, GA, 30309-3915, US

(73) Assignee: KOREA INSTITUTE OF INDUSTRIAL TECHNOLOGY, Chonan-Si (KR)

(21) Appl. No.: 11/596,499

(22) PCT Filed: May 12, 2005
(86) PCT No.: PCT/KR05/01392

§ 371 Date: Aug. 3, 2007

(30) Foreign Application Priority Data
May 12, 2004 (KR) 10-2004-0033304

(51) Int. Cl. G06F 19/00

(52) U.S. Cl. 717/107; 901/50

(57) ABSTRACT

A distributed software integration service method for open robot development based on the Internet is disclosed, which makes it possible to manufacture a user-oriented robot through combination of independent heterogeneous modules. The invention involves a robot development procedure and a new robot development environment/tool for providing user-oriented services and for integrated operating of distributed software installed in the modules over the Internet. The robot development procedure includes three independent specialized development stages, i.e., a platform development stage, a module development stage, and a user-oriented robot development/user service development stage. The invention makes it possible to mass-produce autonomous robots in units of interoperable functional modules. It is also possible to meet various demands of consumers, achieve specialization, and accelerate technology development since the development procedures are specialized in an independent manner and are suitable for manufacturing a wide variety of robot products in small quantities.

### TECHNICAL FIELD

The present invention relates to a method for integrating distributed software of an open distributed autonomous robot, and more particularly to a distributed software integration service method for open robot development based on the Internet, which allows manufacturing of a user-oriented robot through combination of heterogeneous independent modules into a robot through the Internet.

### BACKGROUND ART

In the conventional robot development procedure, individual robot manufacturers carry out collective and comprehensive development. Thus, a single robot manufacturer performs development of control platforms, development of robot control software, and development of a task description language for the user. Such collective development causes robot technologies to be closed, imposing limitations on the introduction of new technologies and making it difficult to achieve compatibility or standardization.

On the other hand, if platforms, which substantially have little relation to robot technologies, are opened, then specialized manufacturers, which guarantee openness, can lead the development of control platforms. Also, in robot development, if it is possible to assemble a robot through combination of separately developed functional modules of the robot, it is possible for existing robot manufacturers to focus on development of specialized parts in an open development environment. Further, easy assembly of a robot through combination of independent functional modules, which may be provided by different manufacturing companies, enables manufacturing of user-oriented robots that can meet various demands of consumers, which it is assumed will lead to expansion of the robot market as a whole. This step-by-step robot development procedure based on openness has not yet been disclosed.

Existing inventions relating to robot software development environments/tools are implemented in various manners and aim to provide various services. However, most conventional robot software development environments/tools are offline robot development environments/tools. Even if online development environments are supported, closed schemes such as one-to-one communications or local networks are employed. Modularized household service robots are previously sold in units of modules in the market, and a system integration procedure is required after purchase. Conventional offline development environments or closed online development environments cannot support a late process for software integration or the like after robots have been placed on the market. Standardized development of modules, which are functional parts constituting robots, and development environments/tools, which enable system integration, i.e., assembly of modules into a robot, have not yet been disclosed.

Specifically, the conventional unified development scheme, in which sales are made after development is completed, cannot be applied to creation of user-oriented services to meet various demands in environments in which independent heterogeneous modules are interoperable. In addition, although it is easy for end consumers to mechanically or electrically combine independent modules using standardized connectors or the like, it is difficult for end consumers to carry out software combination. Further, it is not possible for a specific manufacturer to perform software combination since the functional modules are provided by different manufacturers.

### DISCLOSURE OF INVENTION

### Technical Problem

Therefore, the present invention has been made in view of the above problems, and it is an object of the present invention to provide a distributed software integration service method for open robot development based on the Internet, which allows manufacturing of user-oriented robots through integration of distributed software of modularized robots comprising heterogeneous independent modules over the Internet, and provides development environments/tools and a development procedure on the basis of an open autonomous robot control architecture in distributed environments

The following are features of the present invention.

First, the development procedure is divided into three stages of development, i.e., platform development, module development, robot and user-oriented service development. The developer of each stage must be able to independently perform development without discussion or cooperation with developers of the other stages, and each stage has its unique technology fields.

Second, the development environments/tools are provided for use in robot development and module development having openness, and provides maintenance and repair means using the characteristics of the software components.

Third, the development environments/tools support offline development, development in local network environments, and development in wide area network environments such as the Internet.

Fourth, the development environments/tools provide fast services to the user and provide graphics-based user environments for the purpose of explicit and easy robot development through distributed system integration.

### Technical Solution

In accordance with the present invention, the above and other objects can be accomplished by the provision of a distributed software integration service method for open robot development based on the Internet for developing a user-oriented robot through combination of independent heterogeneous modules, wherein virtual machines, communication middleware, and a real-time channel manager being installed in the independent heterogeneous modules, the virtual machines operating independent software components with spec files standardized in an open distributed processing structure, the communication middleware providing communication paths of the software components, the real-time channel manager analyzing information of late binding of the software components and managing real-time channel usage time of the software components, the method comprising: transmitting module service information and user interface information to a system integrator for software system integration of the modules; the system integrator accessing a user-side home server and requesting that a task description file and the spec files of the modules be downloaded when receiving a request from a user; the home server transmitting the spec files of all the independent functional modules and a task description file of a brain module to a remote development environment of the system integrator when receiving a request from the system integrator; the remote development environment registering the module spec files received from the home server in a database, and extracting information of interfaces and the software components of the modules to generate an API for producing a task description file using a task description language; the system integrator considering a need to add new components to a current set of software components and also to delete and change the current software components through the generated API, and the remote development environment producing new components through a function description language, updating registered spec file information of the modules according to a configuration change of the software components, and changing the API; the system integrator producing a task description file in a graphics based environment or a text based environment using the changed API, and uploading the produced task description file, together with the updated spec files of the modules and newly added or changed software components, to the brain module via the home server; and the brain module uploading spec files required for the independent functional modules and the software components, and the independent functional modules changing existing operating environments of the software components by newly activating virtual machines needed and stopping virtual machines not needed according to the changed spec files.

Preferably, after the installation is completed, the system integrator performs a debugging process through simulation using start, resume, stop, and pause functions provided by the virtual machines, and, through the generated API, the system integrator performs a development process offline until the system integrator uploads the spec files of the modules and the developed task description file to the robot of the user.

Preferably, a task manager, an online reasoning system, an offline planner, and means for interfacing with the Internet, which is a wide area network, are additionally installed in the brain module.

### Advantageous Effects

A distributed software integration service method for open robot development based on the Internet according to the present invention makes it possible to mass-produce autonomous robots in units of interoperable functional modules. Specialization is ensured since manufacturers only have to develop and produce specific functional modules rather than the entirety of the robot system. This makes it possible to accelerate technology development and also to achieve cost reduction through mass production of specific modules. Various demands of consumers can be met since consumers can assemble desired robots by combining functional modules provided in various forms. This makes it possible to expand the robot market as a whole.

### BRIEF DESCRIPTION OF THE DRAWINGS

FIG. 1 is a software architecture diagram showing a hierarchical arrangement of elements of a control system according to the present invention;

FIG. 2 is a diagram illustrating the relationship between a robot control architecture and a development environment/tool;

FIG. 3 is a process flow diagram of robot development;

FIG. 4 is an illustrative diagram showing a robot constructed by combining independent functional modules;

FIG. 5 is an illustrative diagram showing graphics-based system integration environment functions of the development environment/tool; and

FIG. 6 is a diagram showing a 3-stage development procedure of autonomous robots.

### BEST MODE FOR CARRYING OUT THE INVENTION

An embodiment of the present invention will now be described with reference to the accompanying drawings.

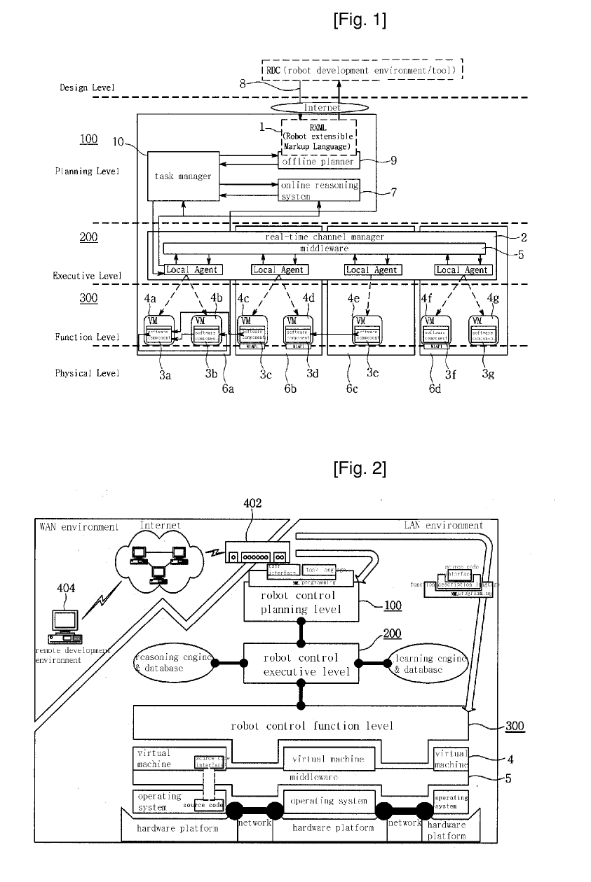

FIG. 1 is a diagram showing a hierarchical arrangement of elements of an open distributed autonomous robot control system according to the present invention.

As shown in FIG. 1, the autonomous robot control architecture according to the present invention has a 3-tier hybrid structure comprising a robot control planning level 100, a robot control executive level 200, and a robot control function level 100. Features of the present invention, which are distinguished from the conventional 3-tier autonomous robot control structure, include a task language (or task description language) 1, which provides a system integration function and openness based on the Internet; a real-time channel manager 2 in a distributed environment; virtual machines 4 (4a, 4b, 4c, 4d, 4e, 4f, 4g) as platform-independent operating environments of software components 3 (3a, 3b, 3c, 3d, 3e, 3f, 3g), which are independent functional entities; communication middleware 5 used for operation and communication of the software components 3 (3a, 3b, 3c, 3d, 3e, 3f, 3g) and a function description language for implementation of the software components 3 (3a, 3b, 3c, 3d, 3e, 3f, 3g); development of independent modules 6 (6a, 6b, 6c, 6d) which constitute a robot; and development of a robot through combination of the modules 6 (6a, 6b, 6c, 6d). The features of the present invention will now be described in detail.

The task language 1 of the robot control planning level 100 is uploaded (denoted by “8”) to a robot over a wide area network such as the Internet or a local area network on which the robot is installed. Further, an offline planner 9 parses the uploaded task language 1, so that it is divided into independent execution units, and thereafter the uploaded task language 1 is transmitted to a task manager 10, so that the real-time channel manager 2 in the robot control executive level 200 finally executes it.

A first feature of the task language 1 according to the present invention is openness. The task language 1 according to the present invention is based on eXtensible Markup Language (XML), which has already been used as a standard language for Internet services in the information industry, so that the task language 1 formally has standardized grammar. The task language 1 according to the present invention is also characterized by easy upload (denoted by “8”) through a wide area network such as the Internet for flexible access environments since a system integration process for combining the modules 6 (6a, 6b, 6c, 6d) into a robot is performed after the modules 6 (6a, 6b, 6c, 6d) are sold.

A second feature of the task language 1 according to the present invention is a distributed-system integration function. The task language 1 according to the present invention has two stages of development procedure for determining description of a mission, which is defined as sequential or conditional execution of a task, and task execution strategies of software components 3 (3a, 3b, 3c, 3d, 3e, 3f, 3g). Particularly, the task language 1 according to the present invention provides a function for late binding of the interfaces of the software components 3 (3a, 3b, 3c, 3d, 3e, 3f, 3g), which are independent functional entities provided respectively inside the distributed modules 6 (6a, 6b, 6c, 6d), thereby providing a maintenance and repair function and a task generation function through a system integration process. Such standardized system integration is performed through the real-time channel manager 2 and is based on the virtual machines 4 (4a, 4b, 4c, 4d, 4e, 4f, 4g) and the communication middleware 5 at the lower levels.

A third feature of the task language 1 according to the present invention is the provision of a user-oriented interface over the Internet. Accordingly, it is possible to use Internet interface techniques in the information technology field without alteration. In addition, user-oriented interface design as demanded by the user is achieved since the interface design is carried out simultaneously with task planning. The offline planner 9 provides the service of the user interface defined in the task language 1 by serving as a server in such a manner that the offline planner 9 receives a task execution result back from the task manager 10 and provides the received task execution result to the wide area network or to the local area network.

The purpose of the real-time channel manager 2 in the robot control executive level 200 is to guarantee real-time performance in the network distributed environment and the multitasking operating system in the conventional autonomous robot control architecture. The real-time channel manager 2 is an entity that analyzes information of late binding of the soft components 3 (3a, 3b, 3c, 3d, 3e, 3f, 3g) and obtains substantial physical addresses to perform inter-process communication in the modules 6 (6a, 6b, 6c, 6d) or network communication between the modules 6 (6a, 6b, 6c, 6d). Such communication is performed on the middleware 5 at the lower level. The real-time channel manager 2 is the only entity that can substantially use a communication path provided by the middleware 5 in the autonomous robot architecture.

In addition, the real-time channel manager 2 optimizes the time when each software component 3 uses a real-time channel. This is accomplished by changing scheduling of processes to be performed prior to the arrival time of periodically performed tasks of the multitasking operating system or periodically generated messages. Here, in the case of a network message, a transmitter operating system task is performed prior to the arrival time, and, in the case of a receiver operating system task, the generation of a network message is performed prior to the arrival time. The real-time channel manager 2 can secure as many available real-time channels as possible by minimizing the software end-to-end transfer time through such a channel management technique.

The software components 3 (3a, 3b, 3c, 3d, 3e, 3f, 3g) in the robot control function level 300 are independent software functional units. The software components 3 (3a, 3b, 3c, 3d, 3e, 3f, 3g) are operated by the virtual machines 4 (4a, 4b, 4c, 4d, 4e, 4f, 4g), so as to guarantee software compatibility in heterogeneous platform environments and also to allow a system integrator 400 to add software components 3 (3a, 3b, 3c, 3d, 3e, 3f, 3g) specific to the user.

The virtual machines 4 (4a, 4b, 4c, 4d, 4e, 4f, 4g) of the robot control function level 300, each of which is a simulated unit of a general Central Processing Unit (CPU), have memory regions. The software components 3 (3a, 3b, 3c, 3d, 3e, 3f, 3g) operated by the virtual machines 4 (4a, 4b, 4c, 4d, 4e, 4f, 4g) provide functions and input and output variables to the interfaces.

All the independent functional modules 6 (6a, 6b, 6c, 6d) store therein standardized spec files of the software components 3 (3a, 3b, 3c, 3d, 3e, 3f, 3g) provided inside the independent functional modules 6 (6a, 6b, 6c, 6d). The spec files can be uploaded and downloaded according to the request from the outside. The spec files, which have been stored in the modules 6 (6a, 6b, 6c, 6d), are downloaded to a brain module 6a, and transferred to an integrated development environment via a wide area network, so that the spec files are used like a general software Application Program Interface (API) when producing a task description file using the task language 1. When there is a need to change the spec files due to addition, deletion, change, etc., of the software components 3, the spec files are changed in the integrated development environment, and the changed spec files are transferred back to the brain module 6a via the wide area network, after which the spec files are uploaded to the modules 6b, 6c, and 6d.

The spec files include an independent function description language that is interpreted and executed in the virtual machines 4 (4a, 4b, 4c, 4d, 4e, 4f, 4g) in order to implement the software components 3 (3a, 3b, 3c, 3d, 3e, 3f, 3g), which are independent functional software units operating on the virtual machines 4 (4a, 4b, 4c, 4d, 4e, 4f, 4g) according to the present invention. The independent function description language is interpreted into code by a dedicated compiler, and the interpreted code is executed by the virtual machines 4 (4a, 4b, 4c, 4d, 4e, 4f, 4g). Although the interpreted code has a similar form to hardware processor machine code, the interpreted code has a platform-independent property since it operates on the virtual machines 4 (4a, 4b, 4c, 4d, 4e, 4f, 4g). The method for the robot function description language to directly access hardware is implemented only through a source code interface provided by the virtual machines 4 (4a, 4b, 4c, 4d, 4e, 4f, 4g). This avoids the possibility that a module developer, who is a novice at the lower platform, may damage hardware stability due to program errors.

A second feature of the robot function description language is that it provides component interfaces, which can be provided to the outside, and also provides a programming function employing an external component interface. This provides the module developer with the same transparent development environment as programming in a single environment instead of programming in a distributed environment.

In the present invention, paths for communication between external components of the modules 6 and for communication between internal components of the modules 6 are provided through the middleware 5. The middleware 5 in the autonomous robot control architecture according to the present invention functions to provide communication in an environment of various heterogeneous networks, and to provide standardized services regardless of the type of network environment. As described above, the real-time channel manager 2 alone uses the service of the middleware 5 in the robot control architecture according to the present invention. When using the service, the real-time channel manager 2 produces a port table using physical transport address information of a message received from the task manager 10, and notifies the middleware 5 of information of the port table when using the service of the middleware 5.

The present invention is also characterized by a standardized and open development environment/tool, which is a development environment for robot development through system integration and development of the modules 6 (6a, 6b, 6c, 6d) presented herein. This development environment may be located in a local environment when supporting the middleware 5 of the present invention and may also be located in a remote area when supporting communication of a wide area network such as the Internet. The present invention also supports offline development of robots when actual communication is not being performed.

The standardized and open development environment/tool is achieved by providing a development environment of an independent function description language in the platform and the standardized task language 1, which is the first feature of the present invention.

For developing the software components 3 (3a, 3b, 3c, 3d, 3e, 3f, 3g) in the stage of developing the modules 6 (6a, 6b, 6c, 6d), the development environment provides, as a function description language development environment, an environment in which it is possible to upload (denoted by “8”) a compiler, a debugger, and completed software components 3 (3a, 3b, 3c, 3d, 3e, 3f, 3g) to the functional modules 6 (6a, 6b, 6c, 6d). The software components 3 (3a, 3b, 3c, 3d, 3e, 3f, 3g), which can be uploaded (denoted by “8”), are bytecodes that have been compiled. Since the implemented code of a source code is present only in the modules 6 (6a, 6b, 6c, 6d) other than in the code of the software components 3 (3a, 3b, 3c, 3d, 3e, 3f, 3g), only the interface can be confirmed in the development environment.

The development environment supports the internet, which is a wide area network communication means, for uploading (denoted by “8”), and additionally supports means for communication with a local network, which is supported by the functional modules 6 (6a, 6b, 6c, 6d). The relationship between the robot control architecture and the development environment according to the present invention is shown in FIG. 2.

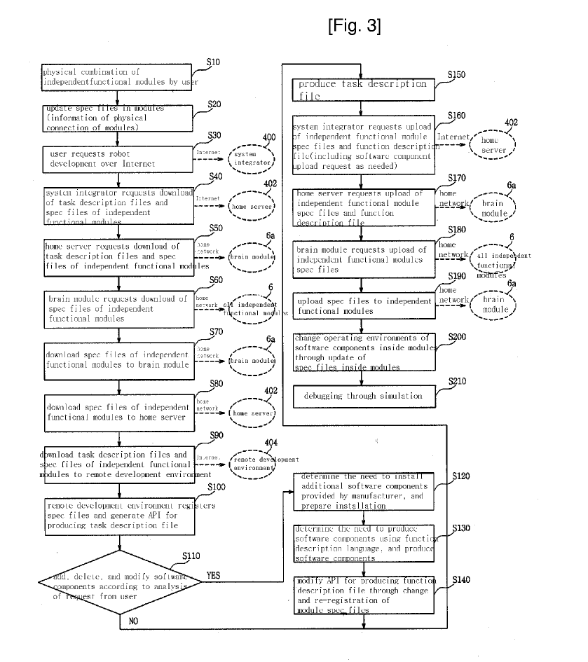

FIG. 3 is a process flow diagram of robot development in the environment of FIG. 2. First, the user separately purchases independent functional modules 6 (6a, 6b, 6c, 6d) to suit their needs, and carries out physical robot system integration through physical combination of the modules (S10).

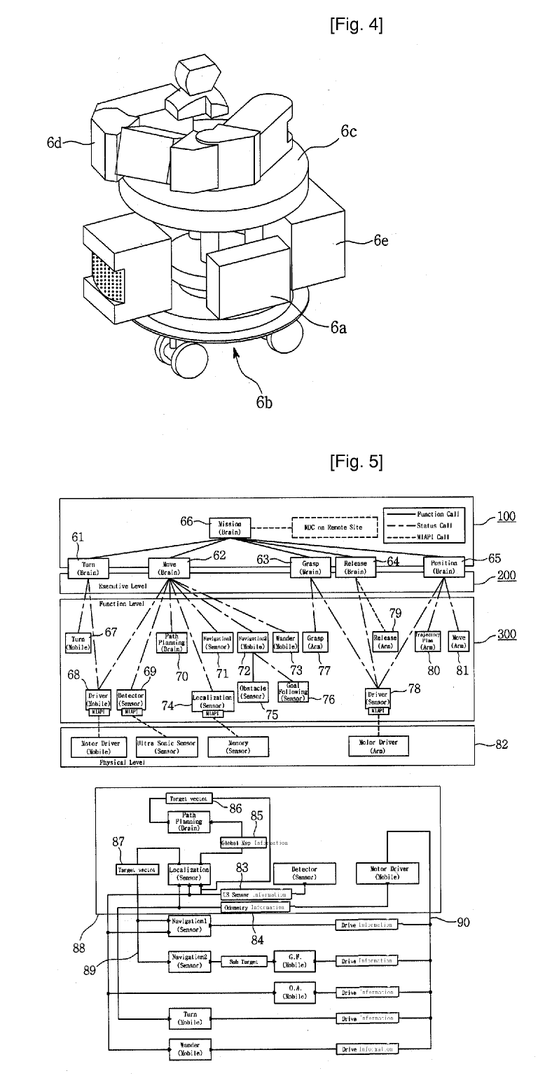

A robot system constructed by combining independent functional modules 6 (6a, 6b, 6c, 6d) by the user is shown in FIG. 4.

As shown in FIG. 4, the robot comprises independent modules, i.e., a brain module 6a, a mobile module 6b, a sensor module 6c, and an arm module 6d. Constructing the robot through system integration using the independent modules 6 (6a, 6b, 6c, 6d) requires each of the modules 6 (6a, 6b, 6c, 6d) to have a basic system structure for integration.

For the basic system structure, the modules 6 (6a, 6b, 6c, 6d) must be provided with a real-time channel manager 2, middleware 5, and virtual machines 4 (4a, 4b, 4c, 4d, 4e, 4f, 4g) that can operate software components 3 (3a, 3b, 3c, 3d, 3e, 3f, 3g) on a software operating system having a real-time performance. These system elements are the most basic elements, which are applied to all the modules 6 (6a, 6b, 6c, 6d). Especially, the brain module 6a must be additionally provided with a task manager 10, an online reasoning system 7, an offline planner 9, and means for interfacing with the Internet, i.e., a wide area network, which are elements for a 3-tier hybrid autonomous robot control architecture.

In such a robot assembly procedure, the individual functional modules 6 (6a, 6b, 6c, 6d) detect their combining states to update spec files (S20).

For software robot system integration after the physical robot system integration, the user transfers information of the request for system integration to a system integrator 400 over the Internet (S30). The system integration request information contains specifications of the user interface on the wide area network and functional service specifications of the robot.

Upon receipt of the request from the user, the system integrator 400 gains access to a user-side home server 402 over the Internet in order to secure information of the specifications of the robot physically integrated by the user, and requests that task description files and spec files of the functional modules 6 (6a, 6b, 6c, 6d) be downloaded (S40).

Upon receipt of the request from the system integrator 400, the home server 402 transfers the request to the brain module 6a, which is a module supporting the wide area network (S50). The brain module 6a again requests the spec files from all the modules 6 (6a, 6b, 6c, 6d) which have been combined (S60), and downloads the spec files (S70). After securing the spec files of all the independent functional modules 6 (6a, 6b, 6c, 6d), the brain module 6a transmits the secured spec files, together with its task description file, to the home server (S80). Upon receipt of the spec files and the task description file, the home server 402 transmits the received files to a remote development environment 404 of the system integrator 400 over the Internet (S90).

After receiving the spec files and the task description file, the remote development environment 404 registers the spec files of the modules 6 (6a, 6b, 6c, 6d) in a database, and extracts information of interfaces and the software components 3 (3a, 3b, 3c, 3d, 3e, 3f, 3g) of the modules 6 (6a, 6b, 6c, 6d) to generate an API for producing a task description file using the task language 1 (S100).

Through the generated API, the system integrator 400 can perform a development process offline until it uploads (denoted by “8”) the spec files of the modules 3 (3a, 3b, 3c, 3d, 3e, 3f, 3g) and the developed task description file to the robot of the user. The system integrator 400 analyzes the request of the user, and considers the need to add new components 3 (3a, 3b, 3c, 3d, 3e, 3f, 3g) to the current set of software components 3 (3a, 3b, 3c, 3d, 3e, 3f, 3g) and the need to delete and change the current software components 3 (3a, 3b, 3c, 3d, 3e, 3f, 3g) (S110). If there is a need to add new components, the system integrator 400 considers whether or not there are suitable ones among software components 3 (3a, 3b, 3c, 3d, 3e, 3f, 3g) provided by manufacturers of the modules 6 (6a, 6b, 6c, 6d) (S120).

The change of the software components 3 (3a, 3b, 3c, 3d, 3e, 3f, 3g) can be made not only at the request of the user but also when the manufacturing companies of the modules 6 (6a, 6b, 6c, 6d) has made a prior request for the change. Thus, manufacturing companies have means for easily changing the software components 3 (3a, 3b, 3c, 3d, 3e, 3f, 3g) when there is a need to upgrade the software components 3 (3a, 3b, 3c, 3d, 3e, 3f, 3g) or when a problem is detected in the software components 3 (3a, 3b, 3c, 3d, 3e, 3f, 3g) installed on the modules 6 (6a, 6b, 6c, 6d) after the modules 6 (6a, 6b, 6c, 6d) have been placed on the market.

When there is a need to produce new components 3 (3a, 3b, 3c, 3d, 3e, 3f, 3g), the remote development environment 404 may produce new components 3 (3a, 3b, 3c, 3d, 3e, 3f, 3g) through a function description language (S130). If the configuration of the software components 3 (3a, 3b, 3c, 3d, 3e, 3f, 3g) is changed in such a manner, the remote development environment 404 updates previously registered spec file information of the modules 6 (6a, 6b, 6c, 6d) and also produces a new API (S140).

Thereafter, the system integrator 400 produces a task description file in a graphics based environment or a text based environment using the changed API (S150). The produced task description file, together with the updated spec files of the modules 6 (6a, 6b, 6c, 6d) and the newly added or changed software components 3 (3a, 3b, 3c, 3d, 3e, 3f, 3g), is uploaded (denoted by “8”) (S170) to the brain module 6a via the home server 402 (S160). The brain module 6a uploads spec files required for the independent functional modules 6 (6a, 6b, 6c, 6d) and the software components 3 (3a, 3b, 3c, 3d, 3e, 3f, 3g) (S190) by making an upload request (S180). The independent functional modules 6 (6a, 6b, 6c, 6d) change existing operating environments of the software components 3 (3a, 3b, 3c, 3d, 3e, 3f, 3g) according to the changed spec files (S200). For example, the independent functional modules 6 (6a, 6b, 6c, 6d) newly activate virtual machines 4 (4a, 4b, 4c, 4d, 4e, 4f, 4g) needed and stop virtual machines 4 (4a, 4b, 4c, 4d, 4e, 4f, 4g) not needed according to the changed spec files.

After the installation is completed, the system integrator 400 performs a debugging process through simulation using start, resume, stop, and pause functions provided by the virtual machines 4 (4a, 4b, 4c, 4d, 4e, 4f, 4g) (S210).

To construct a robot by combining functional modules 6 (6a, 6b, 6c, 6d) provided by different manufacturing companies, it is necessary to produce a task description language 1 including a software integration environment of functional modules 6 (6a, 6b, 6c, 6d) provided by different manufacturing companies. The development environment according to the present invention provides such a development environment. The term “software integration environment” actually refers to a series of processes of downloading spec files representing information of interfaces and the software components 3 (3a, 3b, 3c, 3d, 3e, 3f, 3g) from the independent functional modules 6 (6a, 6b, 6c, 6d); producing a task description file through combination of the interfaces; modifying the spec files if there is a need to add, delete, and change the software components 3 (3a, 3b, 3c, 3d, 3e, 3f, 3g); and uploading (denoted by “8”) the modified spec files back to the modules 6 (6a, 6b, 6c, 6d). The assembly environment of the modules 6 (6a, 6b, 6c, 6d) provides maintenance and repair environments flexible to changes since the spec files and the task description file can be again downloaded, uploaded, and uploaded even after software integration is completed. Since the development and modification environment of the spec files and the task description file is implemented graphically, it is possible to quickly cope with the request of the user and it is also easy for novices to develop programs for the robot.

An example of the system integration using the graphics-based development environment/tool will now be described in detail with reference to FIG. 5.

The software components of FIG. 5 have five task execution strategies, i.e., Turn 61, Move 62, Grasp 63, Release 64, and Position 65. The task execution strategies of the components are used to generate a mission 66. For example, a mission “to move to an absolute coordinate point of (100, 100) and grasp a cup at a height of 100, and move back to the initial position (50, 50) and release the cup” is achieved by performing a series of consecutive tasks as follows.

1st step: Move (100, 100)//To move to an absolute coordinate point of (100, 100).

2nd step: Position (0, 0, 100)//To move an end effector of the arm module 6d to a position at a height of 100.

3rd step: Grasp ( )//To grasp a cup.

4th step: Move (50, 50)//To move back to the initial position at an absolute coordinate point of (50, 50).

5th step: Release ( )//To release the cup.

As described above, which missions 66 the robot can carry out is determined based on which task execution strategies it is possible to establish. That is, if it is possible to establish various task execution strategies, it is possible to generate as various missions 66 as there are task execution strategies. As shown in FIG. 5, a single task execution strategy is achieved through interoperation of one or more software components 3 (3a, 3b, 3c, 3d, 3e, 3f, 3g) required to perform a corresponding task. In FIG. 5, the Turn task strategy 61 is defined by interoperation of a Driver software component 68 and a Turn software component 68 of the mobile module 6b. The Move task strategy 62 is defined by interoperation of a Path Planning software component 70 of the brain module 6a, a Navigation1 software component 71, a Localization software component 74, an Obstacle Avoidance software component 75, a Goal Following software component 76, and a Detector software component 69 of the sensor module 6c, a Navigation software component 72, a Wander software component 73, and a Driver software component 78 of the mobile module 6b. The Grasp task strategy 63 is defined by interoperation of the Driver software component 78 and a Grasp task strategy 77 of the arm module 6d. The Release task strategy 64 is defined by interoperation of a Release software component 79 and the Driver software component 78. The Position task strategy 65 is defined by interoperation of a Trajectory Plan software component 80, a Move software component 81, and the Driver software component of the arm module 6d.

Definition of software components 67 to 81, which are required to be interoperated for each task strategy described in the task description language, is made by calling, by the task manager 10, function interfaces of software components 67 to 81 that are required to be interoperated when there is a need to actually carry out a specific task strategy. Likewise, the definition of the software components 67 to 81 is implemented through the function interfaces of the task manager 10 also when there is a need to perform setting of the software components 67 to 81 or to end the execution. Setting values required when calling function interfaces are transferred through parameters of the functions. Accordingly, all the software components 67 to 81 must provide a function, which can perform at least Start and End operations, for operating through system integration, and can provide functions that can perform selective setting.

Interoperation-based description is performed after the interoperable software components 67 to 81 for each task strategy are defined. The interoperation-based description is a process of late-binding of input variable interfaces and output variable interfaces actually provided by the software components 67 to 81. Accordingly, a pair of a variable interface for input and a variable interface for output, which are required to be integrated, must have the same data type.

The most complicated (i.e., the Move task strategy 62) of the task strategies, which constitute the mission 66, will now be described as an example. Physical resources required for the Move task strategy 62 as a single task include sensor information as an input value such as ultrasonic sensor information and odometry sensor information, and motor driving information as an output value. Access to the physical layer 82 is made through the Motor Driver software component 68 of the mobile module 6b and the Detector software component 69 of the sensor module 6c, which is a software component having a source code interface. The Detector software component 69 and the Motor Driver software component 68 provide interfaces of the odometry sensor information and the ultrasonic sensor information through interface variables, respectively.

On the other hand, the Localization software component 74 receives ultrasonic and odometry sensors through interface variables for input, produces global map information, and provides an interface of the global map through the interface variables. The Localization software component 74 additionally performs path generation, and has an input variable interface and an output variable interface through which the generated path can be received from an external software component and then transferred to another software component at the lower level.

In the interoperation-based description, the sensor information output variable interfaces of the Motor Driver software component 68 and the Detector software component 69 are defined as connections to the sensor information input component of the Localization software component 74 for the purpose of interoperation of the Localization software component 74, the Detector software component 69, and the Motor Driver software component 68 (83, 84).

Likewise, the Path Planning software component 70 has an output variable interface which can provide an interface for a path generated when global map information and an input interface variable for input of the global map information are given. Accordingly, the map input variable interface of the Path Planning software component 70 is defined as a connection to the global map output variable interface of the Localization software component 74 and the generated path output variable interface of the Path Planning software component 70 is defined as a connection to the generated path input variable interface of the Localization software component 74 (85, 86).

The connection definition is associated with a task to simply connect vertices of an overlapping triangle of two rectangular blocks in a graphics-based environment. The interface connection definition is achieved through only four connection tasks. The four connection tasks alone make it possible to realize a task strategy (88) to generate a path through interoperation of distributed software components in the mobile module 6b, the sensor module 6c, and the brain module 6a.

The generated path is transferred to inputs of the Navigation1 and Navigation2 software components 71 and 72 through interface connection of input variables of the Navigation1 and Navigation2 software components 71 and 72 and an output variable of the Localization software component 74 (89). The Navigation1 and Navigation2 software components 71 and 72 control the amount of movement of the robot using an internal obstacle avoidance algorithm and the received path point. The movement amount control value is also transferred to the input variable of the Motor Driver software component 68 through the interface connection (90).

For standardized software components 3 (3a, 3b, 3c, 3d, 3e, 3f, 3g) provided by manufacturing companies of the functional modules 6 (6a, 6b, 6c, 6d), it is difficult to meet various demands of users since the standardized software components 3 (3a, 3b, 3c, 3d, 3e, 3f, 3g) implement only basic functions of the functional modules 6 (6a, 6b, 6c, 6d). The development environment according to the present invention provides a function to produce software components 67 to 81 specific to the user according to various demands of the user, modify interface specifications between the software components 6 (6a, 6b, 6c, 6d) of the existing task description language 1, and provide additional services from the viewpoint of the user.

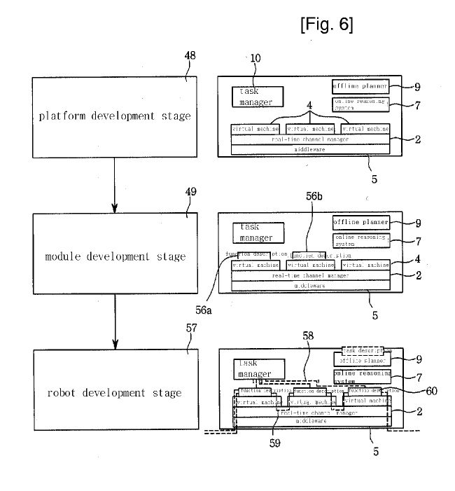

The development procedure disclosed in the present invention divides the development of a single system, i.e., a robot, into three stages, i.e., platform development, module development, and robot development, and each development stage is sequentially and independently carried out. The 3-stage development procedure is shown in FIG. 6.

The first stage of the development procedure is a control platform development stage 48. The control platform development stage 48 includes hardware development and installation of a real-time software operating system, similar to conventional control platform development. The hardware development and the software operating system installation in the development procedure of the present stage 48 can be freely carried out without any limitations.

Features of the control platform development stage 48 according to the present invention include installation of middleware 5, installation of a virtual machine 4 for imparting platform-independent characteristics to development of the subsequent stages, and installation of a real-time channel manager 2, an offline planner 9, and an online reasoning system 7, and a task manager 10 for the autonomous robot control architecture. Another feature of the control platform development stage 48 according to the present invention is the provision of means for allowing application programs of the next stage to directly access platform resources in a limited manner and at a limited level determined by the platform developer. This means can be used for a large-scale computation task, which is hard to handle in the virtual machine, or actual hardware control.

Comprehensively, the purpose of the control platform development stage 48 is to provide open and standardized services in development of application programs using the platform. On the other hand, access to the internal resources of the platform is permitted to a suitable degree, imparting advantages such as system stability and prevention of leakage of unique technologies (i.e., prevention of piracy).

Further, at the platform development stage 48, it is possible to additionally install components of the 3-tier control architecture such as the online reasoning system 7 and the real-time channel manager 2 as needed, and it is also possible to ensure system stability since the user is not permitted to directly access the components of the control architecture.

The second stage of the development procedure is a module development stage 49. The module development stage 49 is the step of producing software components 56a and 56b for independent functional modules based on the platform developed at the platform development stage 48. The software components 56a and 56b must provide standardized interfaces in order to make system integration at the next stage flexible. At the module development stage 49, the software components 56a and 56b are developed using a function description language. The module software developer can confirm the system resource interfaces offline or online, and can incorporate use of these interfaces into the application program procedure. The offline confirmation and use of the interface is achieved via retrieval of an interface description file from a database according to the model of the module and incorporation of the retrieved interface description file into the programming.

The third stage of the development procedure is a robot development stage 57. Development of software components 60 provides development means on the assumption of interfaces 58 and 59 with external components through late binding. That is, the software component 60 is developed on the assumption that proper information is transferred to standard input interfaces provided by components, which are development targets, and information is transferred to components, which use proper information, through output interfaces. Accordingly, the module developer can perform programming without burdens associated with communication programming for actual interfaces or complicated interface relationship of the software components 60. Actual interface connection setting of the software components 60 is carried out at the robot development stage 57. For the purpose of compatibility during actual interface connection setting of the software components 60, the software components 60 must satisfy specifications of standard input and output interfaces prescribed according to the categories to which the software components belong. Thus, it is possible to implement software components 60 that can meet various additional demands of users.

The above embodiments are merely examples for implementing a distributed software integration service method for open robot development based on the Internet according to the present invention. The present invention is not limited to the above embodiments, and various modifications are possible by a person having ordinary knowledge in the art without departing from the spirit of the invention.

### INDUSTRIAL APPLICABILITY

As described above, a distributed software integration service method for open robot development based on the Internet according to the present invention makes it possible to mass-produce autonomous robots in units of interoperable functional modules. Specialization is ensured since manufacturers only have to develop and produce specific functional modules rather than the entirety of the robot system. This makes it possible to accelerate technology development and also to achieve cost reduction through mass production of specific modules. Various demands of consumers can be met since consumers can assemble desired robots by combining functional modules provided in various forms. This makes it possible to expand the robot market as a whole.

1. A distributed software integration service method for open robot development based on the Internet for developing a user-oriented robot through combination of independent heterogeneous modules, wherein virtual machines, communication middleware, and a real-time channel manager being installed in the independent heterogeneous modules, the virtual machines operating independent software components with spec files standardized in an open distributed processing structure, the communication middleware providing communication paths of the software components, the real-time channel manager analyzing information of late binding of the software components and managing real-time channel usage time of the software components, the method comprising:
transmitting module service information and user interface information to a system integrator for software system integration of the modules;
the system integrator accessing a user-side home server and requesting that a task description file and the spec files of the modules be downloaded when receiving a request from a user;
the home server transmitting the spec files of all the independent functional modules and a task description file of a brain module to a remote development environment of the system integrator when receiving a request from the system integrator;
the remote development environment registering the module spec files received from the home server in a database, and extracting information of interfaces and the software components of the modules to generate an API for producing a task description file using a task description language;
the system integrator considering a need to add new components to a current set of software components and also to delete and change the current software components through the generated API, and the remote development environment producing new components through a function description language, updating registered spec file information of the modules according to a configuration change of the software components, and changing the API;
the system integrator producing a task description file in a graphics based environment or a text based environment using the changed API, and uploading the produced task description file, together with the updated spec files of the modules and newly added or changed software components, to the brain module via the home server; and
the brain module uploading spec files required for the independent functional modules and the software components, and the independent functional modules changing existing operating environments of the software components by newly activating virtual machines needed and stopping virtual machines not needed according to the changed spec files.

2. The distributed software integration service method according to claim 1, wherein, after the installation is completed, the system integrator performs a debugging process through simulation using start, resume, stop, and pause functions provided by the virtual machines.

3. The distributed software integration service method according to claim 1, wherein, through the generated API, the system integrator performs a development process offline until the system integrator uploads the spec files of the modules and the developed task description file to the robot of the user.

4. The distributed software integration service method according to claim 1, wherein a task manager, an online reasoning system, an offline planner, and means for interfacing with the Internet, which is a wide area network, are additionally installed in the brain module.

5. A distributed software integration service method for open robot development based on the Internet, the method comprising:
a platform development stage for developing a control platform upon which are installed virtual machines, communication middleware, a reasoning system, an offline planner, a real-time manager, and a task manager for a robot control architecture, the virtual machines operating independent software components with spec files standardized in an open distributed processing structure, the communication middleware providing communication paths of the software components;
a module development stage for producing software components for independent functional modules based on the platform developed at the platform development stage; and
a robot development stage for developing a user-oriented robot by integrating a plurality of independent heterogeneous modules developed at the module development stage based on an interface with an external component through late binding.

6. The distributed software integration service method according to claim 5, wherein an integration development environment supporting both robot development through integration of the modules and the module development is provided.
